(19) United States
(12) Patent Application Publication
(10) Pub. No.: US 2022/0371186 A1
(43) Pub. Date: Nov. 24, 2022

(54) Dual-robot position/force multivariate-data-driven method using reinforcement learning

(71) Applicant: GUANGZHOU INSTITUTE OF ADVANCED TECHNOLOGY, Guangzhou (CN)

(72) Inventors: Gong Zhang, Guangzhou (CN); Yueyu Wu, Guangzhou (CN); Qi Zhu, Guangzhou (CN); Xufei Chen, Guangzhou (CN); Mengdi Liu, Guangzhou (CN); Zijian Lin, Guangzhou (CN); Si Di, Guangzhou (CN); Hai Yuan, Guangzhou (CN)

(21) Appl. No.: 17/751,024

(22) Filed: May 23, 2022

Related U.S. Application Data
(63) Continuation of application No. PCT/CN2021/095966, filed on May 26, 2021.

(30) Foreign Application Priority Data
May 19, 2021 (CN) 202110547805.8

(51) Int. Cl. B25J 9/16; B25J 9/00

(52) U.S. Cl. CPC B25J 9/163; B25J 9/0087

(57) ABSTRACT

Disclosed is a dual-robot position/force multivariate-data-driven method using reinforcement learning. A master robot adopts an ideal position meta-control strategy, learns a desired position by a reinforcement learning algorithm, and feeds back an actual position to a desired position, and a goal is to generate an optimal force while the robot interacts with the environment, as to minimize a position error; and a slave robot, based on a force meta-control strategy of position deviation of the master robot, adopts a damping proportional-derivative (PD) control strategy suitable for an unknown environment, and learns a desired acting force by the reinforcement learning algorithm, namely a minimum force for driving the slave robot to approach a desired reference point. The present invention may improve the dexterity of dual-robot collaboration, solve a parameter optimization problem in position/force control.

### CROSS REFERENCE TO RELATED APPLICATION

This application is a continuation of International Patent Application No. PCT/CN2021/095966, filed on May 26, 2021, which claims priority benefit of Chinese Patent Application No. 202110547805.8, filed on May 19, 2021, and the entire contents of which are incorporated herein by reference.

### TECHNICAL FIELD

The present invention relates to the technical field of multi-robot collaborative control, in particular to a dual-robot position/force multivariate-data-driven method using reinforcement learning.

### BACKGROUND

With the continuous changes in processing volume and operating environment of complex components industries such as steel/aluminum, some tasks may not be undertaken by a single robot alone, and may only be completed by the collaborative operation of multi-robot system. A multi-robot collaborate operation replaces a single robot already and becomes a research hotspot for building an intelligent production line. Compared with a single-robot system, a multi-robot system has the characteristics of strong adaptability to the environment, high self-adjustment ability, wide system space distribution, better data redundancy, robustness and the like. The collaboration between the multi-robot used may reliably complete complex tasks such as a high-precision operation and efficient processing that may not be completed by the single robot.

While the multi-robot collaborates to carry a same object, there are physical links and internal force constraints between the robots. In order to achieve tight coupling, an effective position-force coordination control strategy must be implemented, to improve the flexibility and stability of multi-robot collaborative operation.

There are researches on the coordinated control of dual-robot already, and many control strategies are applied to a slave robot. The optimal control of a master robot is not fully considered, and the concept of tracking control of the slave robot to the master robot is not involved. Many robot position-force control schemes assume accurate understanding of a dynamic model, but a cooperative dynamic model of multi-robot is highly uncertain, and faces interference from external uncertain environments and the like, so a model-based control method is not enough to deal with such an uncertain system.

The collaborative control operation of multi-robot applied to complex tasks requires the research of interaction between the robot and the environment. While the environment is unknown, the force control is not sufficient to produce the desired strength for uncertainty in the environment. How to solve a parameter optimization problem in the position/force control by implementing the effective position-force collaborative control strategy, avoid a larger error in a transient state, and achieve the flexibility and stability of dual-robot collaborative carrying and turning, is a key problem to be solved at present.

### SUMMARY

In view of this, in order to solve the above problem in an existing technology, the present invention provides a dual-robot position/force multivariate-data-driven method using reinforcement learning. A master robot adopts an ideal position meta-control strategy, and learns a desired position by a reinforcement learning algorithm; and a slave robot, based on a force meta-control strategy of position deviation of the master robot, adopts a damping PD control strategy suitable for an unknown environment, and learns a desired acting force by the reinforcement learning algorithm.

The present invention solves the above problem by the following technical means.

A dual-robot position/force multivariate-data-driven method using reinforcement learning, including the following steps:

Acquiring an actual position, an actual velocity and an actual accelerated velocity of an end effector of a master robot and a slave robot in a task space;

Using the actual position, the actual velocity and actual accelerated velocity of the end effector of the master robot and the slave robot in the task space, and establishing a dual-robot mechanical damping system model.

According to a dynamic force balance equation of the double-robot mechanical damping system model, acquiring a sucker acting force of the master robot and the slave robot, herein the sucker acting force of the master robot is an actual applied force of the master robot, and the sucker acting force of the slave robot is an actual applied force of the slave robot.

Adopting an ideal position meta-control strategy by the master robot, learning a desired position by a reinforcement learning algorithm, adopting a proportional derivative control rate according to the actual applied force of the master robot, adjusting a derivative coefficient and a proportional coefficient, and feeding back the actual position to the desired position, herein while the master robot does not contact with the environment, the actual position of the mater robot follows the desired position; and while the master robot contacts with the environment, the desired position of the master robot is modified and updated by position PD control, and the actual position of the master robot follows a new desired position; and

based on a force meta-control strategy of position deviation of the mater robot, adopting a damping PD control strategy suitable for an unknown environment by the slave robot, learning a desired acting force by the reinforcement learning algorithm, and by comparing an error value between the desired acting force and the actual applied force of the slave robot, converting a force error feedback signal into a velocity correction amount at an end of the slave robot; and then using admittance control to generate a desired reference position, and maintaining a relationship between the desired acting force and the desired reference position of the slave robot.

Further, the step of acquiring the actual position, the actual velocity and the actual accelerated velocity of the end effector of the master robot and the slave robot in the task space is specifically as follows.

On the robot end effector, the joint space dynamics of an n-link robot with a force sensor may be written as:

M(q)\ddot{q}+C(q,\dot{q})\dot{q}+G(q)=τ−f^{T}(q)fₑ (1)

Where, q, \dot{q}, and \ddot{q} are joint position, velocity and accelerated velocity, respectively; M(q) is a symmetric positive definite inertia matrix; C(q, \dot{q}) represents a centripetal and Coriolis torque matrix; G(q) is a gravitational torque vector; τ is a driven torque vector; fₑ is an external force measured by the force sensor; and f(q) is a Jacobian matrix that maps the external force vector fₑ to the generalized coordinates, satisfying:

\dot{x}=f(q)\dot{q}, \ddot{x}=f(q)\ddot{q}+\dot{f}(q)\dot{q} (2)

Where, \dot{x} and \ddot{x} are the actual velocity and the actual accelerated velocity of the robot end effector in the task space, respectively, and \dot{x} is a first-order derivative of the actual position x of the robot end effector in the task space.

Further, the step of establishing the dual-robot mechanical damping system model is specifically as follows.

While the robot end effector contacts with the environment, modeling may be performed by a spring-damper model:

fₑ=−Cₑ\dot{x}+Kₑ(xₑ−x) (3)

Where, Cₑ and Kₑ are environmental damping and stiffness constant matrixes respectively; xₑ is a position of the environment; while x≥xₑ, there is an interaction force between the robot end effector and the environment; and conversely, while x<xₑ, there is no interaction force; and

Under an ideal working condition, while two robot end suckers clamp a workpiece, there is no any relative movement between mechanisms, it may be regarded that a rigid body of the slave robot and a rigid body of the mater robot clamping the workpiece are coupled with each other in mechanical damping of the sensor, to obtain the dual-robot mechanical damping system model.

Further, the step of, according to the dynamic force balance equation of the dual-robot mechanical damping system model, acquiring the sucker acting force of the master robot is specifically as follows.

According to the dynamic force balance equation of the dual-robot mechanical damping system model, on the master robot side, the sucker acting force f₁ is:

f₁=kₛ(x₁−x₂)+bₛ(\dot{x}₁−\dot{x}₂)+m₁\ddot{x}₁ (4)

Where, f₁ is the actual applied force of the master robot; kₛ is an environmental stiffness coefficient; bₛ is an environmental damping coefficient; x₁ is the actual position of the master robot; x₂ is the actual position of the slave robot; \dot{x}₁ is the actual velocity of the mater robot; \dot{x}₂ is the actual velocity of the slave robot; \dot{x}₁ is the actual accelerated velocity of the mater robot; and m₁ is the sum of masses of the sucker of the mater robot and the workpiece.

Further, the step of, according to the dynamic force balance equation of the dual-robot mechanical damping system model, acquiring the sucker acting force of the slave robot is specifically as follows.

On the slave robot side, the sucker acting force f₂ is:

f₂=kₛ(x₁−x₂)+bₛ(\dot{x}₁−\dot{x}₂)+m₂\ddot{x}₂ (5)

Where, f₂ may be equivalent to the external force fₑ measured by the force sensor installed on a wrist portion of the robot; kₛ is the environmental stiffness coefficient; bₛ is the environmental damping coefficient; x₁ is the actual position of the master robot; x₂ is the actual position of the slave robot; \dot{x}₁ is the actual velocity of the master robot; \dot{x}₂ is the actual velocity of the slave robot; \ddot{x}₂ is the actual accelerated velocity of the slave robot; and m₂ is the mass of the sucker of the slave robot.

Further, the step of feeding back the actual position to the desired position by the master robot is specifically as follows.

A proportional-derivative control law based on the position error value is applied, and the output is the force correction amount; and the position control law for the master robot is expressed as:

f₁=kₚ_{ₓ}eₓ+k_{d}_{ₓ}ėₓ+f_{d}, eₓ=x_{d}−x₁ (6)

Where, f₁ is the actual applied force of the master robot, f_{d} is the desired acting force of the slave robot; x_{d} is the desired position of the master robot; eₓ and ėₓ are position offset error and velocity error of the master robot respectively; kₚ_{ₓ} is a position control proportional coefficient; k_{d}_{ₓ} is a position control derivative coefficient; and x₁ is the actual position of the master robot.

Further, the step of converting the force error feedback signal into the velocity correction amount at the end of the slave robot by the slave robot is specifically as follows.

The damping control law for the slave robot is expressed as:

\dot{x}₂=kₚ_{_{f}}e_{f}+k_{d}_{_{f}}ė_{f}, e_{f}=f_{d}−f₂ (7)

Where, \dot{x}₂ is the velocity correction amount of the slave robot, namely the actual velocity of the slave robot; e_{f} is the force error value of the slave robot; ė_{f} is a force change rate error value of the slave robot; kₚ_{_{f}} is a force control proportional coefficient; k_{d}_{_{f}} is a force control derivative coefficient; f_{d} is the desired acting force of the slave robot; and f₂ is the actual applied force of the slave robot.

Compared with the existing technology, the beneficial effects of the present invention at least include the followings.

The master robot of the present invention adopts the ideal position meta-control strategy, and learns the desired position by the reinforcement learning algorithm; the slave robot, based on the force meta-control strategy of the position deviation of the master robot, adopts the damping PD control strategy suitable for the unknown environment, and learns the desired acting force by the reinforcement learning algorithm. The position/force multivariate-data-driven method under the reinforcement learning may be used, to improve the dexterity of dual-robot collaboration, solve the parameter optimization problem in the position/force control, and avoid the larger error in the transient state.

### BRIEF DESCRIPTION OF THE DRAWINGS

In order to describe technical schemes in embodiments of the present invention more clearly, drawings used in the descriptions of the embodiments are briefly introduced below. Apparently, the drawings in the following descriptions are only some embodiments of the present invention. For those of ordinary skill in the art, other drawings may also be obtained according to these drawings without creative work.

FIG. 1 is a schematic diagram of synergistic clamping, carrying and turning of a dual-robot of the present invention.

FIG. 2 is a dual-robot mechanical damping system model of the present invention.

FIG. 3 is a block diagram of a dual-robot reinforcement learning multivariate-data driven mode of the present invention.

### DETAILED DESCRIPTION OF THE EMBODIMENTS

In order to make the above purposes, features and advantages of the present invention more clearly understood, the technical schemes of the present invention are described in detail below in combination with the drawings and specific embodiments. It should be pointed out that the described embodiments are only a part of the embodiments of the present invention, rather than all the embodiments. Based on the embodiments of the present invention, all other embodiments obtained by those of ordinary skill in the art without creative work fall within the scope of the protection of the present invention.

The collaborative clamping, carrying and turning of a workpiece by dual-robot in the same station area requires the study of interaction between the robot and the environment. A most commonly used interactive control method is position-force control. While the environment is unknown, the position/force control is not sufficient to produce the desired strength for uncertainty in the environment, and in order to acquire the position/force control, its desired value needs to be estimated.

Machine Learning (ML) is a technology that realizes functions such as human learning ability by a computer. Reinforcement Learning (RL) is that a machine learning model is trained, so that the robot, in an uncertain and potential complex environment, and in the case without an accurate system model, selects an action to be executed according to the environment, programs a goal in a mode of reward or punishment, and then learns to achieve the goal. RL estimates its function by analyzing and measuring system trajectory data, thereby its control behavior is improved in real time, and it may be widely used in the fields of robot control, scheduling and the like.

A most widely used reinforcement learning algorithm is Q-Learning, this is an iterative algorithm, its goal is to maximize a desired value of the total reward, it is also an optimal behavior selection strategy in a Markov decision process, and it does not need an environment model. Thereby, the synergistic performance of the double robots is improved, the parameter optimization problem in the position/force control is solved, and the larger error in the transient state is avoided. Real-time tracking is achieved while two robots cooperate to carry the same rigid body, and the robustness of robot dynamic uncertainty is maintained.

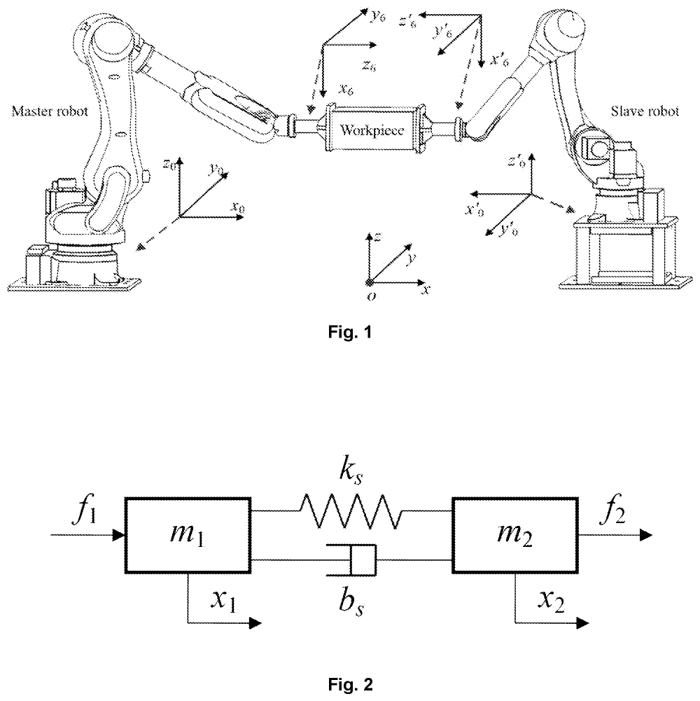

A schematic diagram of coordinate calibration of dual-robot collaborative carrying is shown in FIG. 1. A master-slave collaborative control mode is adopted, ends of the master and slave robots are loaded with pneumatic suckers respectively, and a main sucker and an auxiliary sucker clamp the same workpiece, to execute a complex carrying trajectory. In the figure, a point O is an origin of a world coordinate system, and (xᵢ, yᵢ, zᵢ) represents an existing axial joint coordinate system. A base coordinate of the robot is center-symmetrical relative to the point O, and a z-axis of an end joint coordinate system is center-symmetrical relative to the rotation.

On the robot end effector, the joint space dynamics of an n-link robot with a force sensor may be written as:

M(q)\ddot{q}+C(q,\dot{q})\dot{q}+G(q)=τ−f^{T}(q)fₑ (1)

Where, q, \dot{q}, and \ddot{q} are joint position, velocity and accelerated velocity respectively; M(q) is a symmetric positive definite inertia matrix; C(q, \dot{q}) represents a centripetal and Coriolis torque matrix; G(q) is a gravitational torque vector; τ is a driving torque vector; fₑ is an external force measured by the force sensor; and f(q) is a Jacobian matrix that maps the external force vector fₑ to the generalized coordinates, satisfying:

\dot{x}=f(q)\dot{q}, \ddot{x}=f(q)\ddot{q}+\dot{f}(q)\dot{q} (2)

Where, \dot{x} and \ddot{x} are the actual velocity and the actual accelerated velocity of the robot end effector in the task space respectively, and \dot{x} is a first-order derivative of the actual position x of the robot end effector in the task space.

While the robot end effector contacts with the environment, modeling may be performed by a spring-damper model (Kelvin-Voigt model):

fₑ=−Cₑ\dot{x}+Kₑ(xₑ−x) (3)

Where, Cₑ and Kₑ are environmental damping and stiffness constant matrixes respectively; xₑ is a position of the environment; while x≥xₑ, there is an interaction force between the robot end effector and the environment; and conversely, while x<xₑ, there is no interaction force.

Under an ideal working condition, while two robot end suckers clamp a workpiece, there is no any relative movement between mechanisms, it may be regarded that a rigid body of the slave robot and a rigid body of the mater robot clamping the workpiece are coupled with each other in mechanical damping of the sensor, to obtain the dual-robot mechanical damping system model, as shown in FIG. 2. According to the dynamic force balance equation of the dual-robot mechanical damping system model, on the master robot side, the sucker acting force f₁ is:

f₁=kₛ(x₁−x₂)+bₛ(\dot{x}₁−\dot{x}₂)+m₁\ddot{x}₁ (4)

Where, f₁ is the actual applied force of the master robot; kₛ is an environmental stiffness coefficient; bₛ is an environmental damping coefficient; x₁ is the actual position of the master robot; x₂ is the actual position of the slave robot; and m₁ is the sum of masses of the sucker of the mater robot and the workpiece.

On the slave robot side, the sucker acting force f₂ is:

f₂=kₛ(x₁−x₂)+bₛ(\dot{x}₁−\dot{x}₂)+m₂\ddot{x}₂ (5)

Where, f₂ may be equivalent to the external force fₑ measured by the force sensor installed on a wrist portion of the robot; and m₂ is the mass of the sucker of the slave robot.

The master robot adopts the ideal position meta-control strategy, learns the desired position by the reinforcement learning algorithm, and feeds back the actual position to the desired position. The goal is to generate an optimal force while the robot interacts with the environment, as to minimize the position error. A Proportional-Derivative (PD) control law based on the position error value is applied, and the output is the force correction amount. The position control law for the master robot is expressed as:

f₁=kₚ_{ₓ}eₓ+k_{d}_{ₓ}ėₓ+f_{d}, eₓ=x_{d}−x₁ (6)

Where, f_{d} is the desired acting force of the slave robot; x_{d} is the desired position of the master robot; eₓ and eₓ are position offset error and velocity error of the master robot respectively; kₚ_{ₓ} is a position control proportional coefficient; and k_{d} is a position control derivative coefficient.

While there is no contact force, the master robot actual position x₁ follows the desired position x_{d}. While the robot contacts with the environment, the master robot desired position x_{d} is modified and updated by the position PD control, and the master robot actual position follows a new desired position.

On the other hand, based on the environmental stiffness and damping model, the slave robot must track a real-time motion state of the master robot in real time. Therefore, a damping PD control strategy suitable for an unknown environment is adopted, and the desired acting force is learned by the reinforcement learning algorithm, namely a minimum force for driving the slave robot to approach a desired reference point, a desired force may be obtained by a reinforcement learning method, and this force is the minimum force required for the robot to approach its reference point. The desired reference position is then generated by using admittance control, and a relationship between the desired acting force and the desired reference position of the slave robot is maintained.

In view of the velocity and position parameters at the end of the robot, the damping PD control is adopted, and by comparing an error value between the desired acting force and the actual acting force of the slave robot, a force error feedback signal is converted into a velocity correction amount at the end of the slave robot. The damping control law for the slave robot is expressed as:

\dot{x}₂=kₚ_{_{f}}e_{f}+k_{d}_{_{f}}ė_{f}, e_{f}=f_{d}−f₂ (7)

Where, \dot{x}₂ is the velocity correction amount of the slave robot; e_{f} is the force error value of the slave robot; ė_{f} is a force change rate error value of the slave robot; kₚ_{_{f}} is a force control proportional coefficient; and k_{d}_{_{f}} is a force control derivative coefficient.

In order to accelerate the convergence speed of learning, the Q-learning algorithm is modified by Eligibility Traces, and a better method may be provided for assigning a credit to visit a state. It may be attenuated with time, thus the recently visited state is more eligible for a credit reward, and thereby the convergence speed of the reinforcement learning is accelerated.

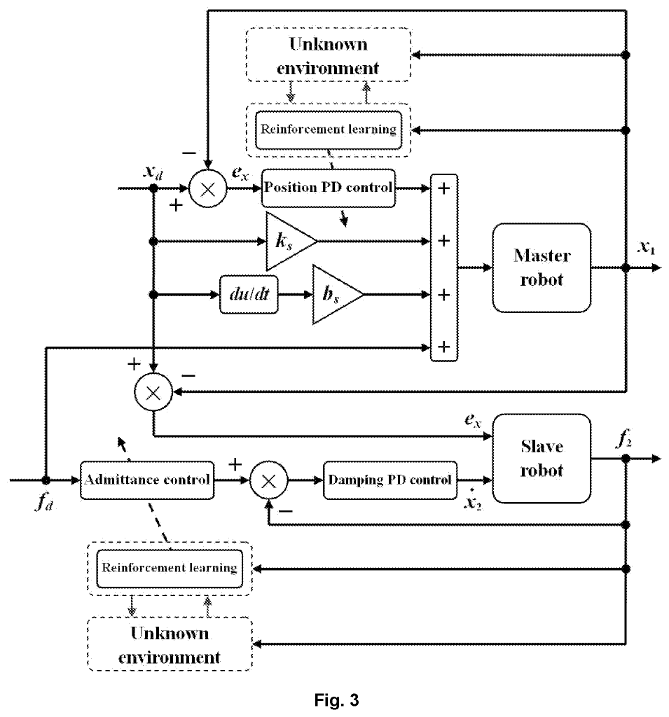

Based on the above analysis, a block diagram of a dual-robot reinforcement learning multivariate-data-driven mode may be obtained, as shown in FIG. 3, it is a dual-input and dual-output system. The input is: the master robot desired position x_{d}, and the slave robot desired acting force f_{d}; and the output is: the master robot actual position x₁, and the slave robot actual applied force f₂.

The master robot adopts the ideal position meta-control strategy, learns the desired position by the reinforcement learning algorithm, and feeds back the actual position to the desired position, and the goal is to generate an optimal force while the robot interacts with the environment, as to minimize the position error; and the slave robot, based on the force meta-control strategy of position deviation of the master robot, adopts the damping PD control strategy suitable for the unknown environment, and learns the desired acting force by the reinforcement learning algorithm, namely the minimum force for driving the slave robot to approach the desired reference point. The desired reference position is then generated by using the admittance control, and the relationship between the desired acting force and the desired reference position of the slave robot is maintained. Namely, the master and slave robots learn the desired position and the desired acting force respectively by the reinforcement learning algorithm, and use the proportional-derivative control rate, to adjust the respective proportional coefficient (kₚ) and derivative coefficient (k_{d}).

The above embodiments only represent several implementation modes of the present invention, and the descriptions thereof are more specific and detailed, but should not be construed as limitation to a patent scope of the present invention. It should be pointed out that for those of ordinary skill in the art, without departing from the concept of the present invention, a plurality of modifications and improvements may also be made, and these all belong to a scope of protection of the present invention. Therefore, the scope of protection of the patent of the present invention should be subject to the appended claims.

What is claimed is:

1. A dual-robot position/force multivariate-data-driven method using reinforcement learning, comprising the following steps:
Acquiring an actual position, an actual velocity and an actual accelerated velocity of an end effector of a master robot and a slave robot in a task space;
Using the actual position, the actual velocity and actual accelerated velocity of the end effector of the master robot and the slave robot in the task space, and establishing a dual-robot mechanical damping system model;
According to a dynamic force balance equation of the double-robot mechanical damping system model, acquiring a sucker acting force of the master robot and the slave robot, wherein the sucker acting force of the master robot is an actual applied force of the master robot, and the sucker acting force of the slave robot is an actual applied force of the slave robot;
Adopting an ideal position meta-control strategy by the master robot, learning a desired position by a reinforcement learning algorithm, adopting a proportional derivative control rate according to the actual applied force of the master robot, adjusting a derivative coefficient and a proportional coefficient, and feeding back the actual position to the desired position, wherein while the master robot does not contact with the environment, the actual position of the mater robot follows the desired position; and while the master robot contacts with the environment, the desired position of the master robot is modified and updated by position PD control, and the actual position of the master robot follows a new desired position; and
based on a force meta-control strategy of position deviation of the mater robot, adopting a damping PD control strategy suitable for an unknown environment by the slave robot, learning a desired acting force by the reinforcement learning algorithm, and by comparing an error value between the desired acting force and the actual applied force of the slave robot, converting a force error feedback signal into a velocity correction amount at an end of the slave robot; and then using admittance control to generate a desired reference position, and maintaining a relationship between the desired acting force and the desired reference position of the slave robot.

2. The double-robot position/force multivariate-data-driven method using the reinforcement learning as claimed in claim 1, wherein the step of acquiring the actual position, the actual velocity and the actual accelerated velocity of the end effector of the master robot and the slave robot in the task space is specifically as follows:
On the robot end effector, the joint space dynamics of an n-link robot with a force sensor can be written as:
M(q)\ddot{q}+C(q,\dot{q})\dot{q}+G(q)=τ−f^{T}(q)fₑ (1)
Where, q, \dot{q}, and \ddot{q} are joint position, velocity and accelerated velocity respectively; M(q) is a symmetric positive definite inertia matrix; C(q, \dot{q}) represents a centripetal and Coriolis torque matrix; G(q) is a gravitational torque vector; τ is a driving torque vector; fₑ is an external force measured by the force sensor; and f(q) is a Jacobian matrix that maps the external force vector fₑ to the generalized coordinates, satisfying:
\dot{x}=f(q)\dot{q}, \ddot{x}=f(q)\ddot{q}+\dot{f}(q)\dot{q} (2)
Where, \dot{x} and \ddot{x} are the actual velocity and the actual accelerated velocity of the robot end torque matrix in the task space respectively, and \dot{x} is a first-order derivative of the actual position x of the robot end torque matrix in the task space.

3. The dual-robot position/force multivariate-data-driven method using the reinforcement learning as claimed in claim 2, wherein the step of establishing the dual-robot mechanical damping system model is specifically as follows:
While the robot end executor contacts with the environment, modeling can be performed by a spring-damper model:
fₑ=−Cₑ\dot{x}+Kₑ(xₑ−x) (3)
Where, Cₑ and Kₑ are environmental damping and stiffness constant matrixes respectively; xₑ is a position of the environment; while x≥xₑ, there is an interaction force between the robot end effector and the environment; and conversely, while x<xₑ, there is no interaction force; and
Under an ideal working condition, while two robot end suckers clamp a workpiece, there is no any relative movement between mechanisms, it can be regarded that a rigid body of the slave robot and a rigid body of the mater robot clamping the workpiece are coupled with each other in mechanical damping of the sensor, to obtain the dual-robot mechanical damping system model.

4. The dual-robot position/force multivariate-data-driven method using the reinforcement learning as claimed in claim 2, wherein the step of, according to the dynamic force balance equation of the dual-robot mechanical damping system model, acquiring the sucker acting force of the master robot is specifically as follows:
According to the dynamic force balance equation of the dual-robot mechanical damping system model, on the master robot side, the sucker acting force f₁ is:
f₁=kₛ(x₁−x₂)+bₛ(\dot{x}₁−\dot{x}₂)+m₁\ddot{x}₁ (4)
Where, f₁ is the actual applied force of the master robot; kₛ is an environmental stiffness coefficient; bₛ is an environmental damping coefficient; x₁ is the actual position of the master robot; x₂ is the actual position of the slave robot; \dot{x}₁ is the actual velocity of the mater robot; \dot{x}₂ is the actual velocity of the slave robot; \ddot{x}₁ is the actual accelerated velocity of the mater robot; and m₁ is the sum of masses of the sucker of the mater robot and the workpiece.

5. The dual-robot force/position multivariate data driving method based on the reinforcement learning as claimed in claim 1, wherein the step of, according to the dynamic force balance equation of the double-robot mechanical damping system model, acquiring the sucker acting force of the slave robot is specifically as follows:
On the slave robot side, the sucker acting force f₂ is:
f₂=kₛ(x₁−x₂)+bₛ(\dot{x}₁−\dot{x}₂)+m₂\ddot{x}₂ (5)
Where, f₂ can be equivalent to the external force fₑ measured by the force sensor installed on a wrist portion of the robot; kₛ is the environmental stiffness coefficient; bₛ is the environmental damping coefficient; x₁ is the actual position of the master robot; x₂ is the actual position of the slave robot; \dot{x}₁ is the actual velocity of the master robot; \dot{x}₂ is the actual velocity of the slave robot; \ddot{x}₂ is the actual accelerated velocity of the slave robot; and m₂ is the mass of the sucker of the slave robot.

6. The dual-robot position/force multivariate-data-driven method using the reinforcement learning as claimed in claim 1, wherein the step of feeding back the actual position to the desired position by the master robot is specifically as follows:
A proportional-derivative control law based on the position error value is applied, and the output is the force correction amount; and the position control law for the master robot is expressed as:
f₁=kₚ_{ₓ}eₓ+k_{d}_{ₓ}ėₓ+f_{d}, eₓ=x_{d}−x₁ (6)
Where, f₁ is the actual applied force of the master robot, f_{d} is the desired acting force of the slave robot; x_{d} is the desired position of the master robot; eₓ and ėₓ are position offset error and velocity error of the master robot respectively; kₚ_{ₓ} is a position control proportional coefficient; k_{d}_{ₓ} is a position control derivative coefficient; and x₁ is the actual position of the master robot.

7. The dual-robot position/force multivariate-data-driven method using the reinforcement learning as claimed in claim 1, wherein the step of converting the force error feedback signal into the velocity correction amount at the end of the slave robot by the slave robot is specifically as follows:
The damping control law for the slave robot is expressed as:
\dot{x}₂=kₚ_{_{f}}e_{f}+k_{d}_{_{f}}ė_{f}, e_{f}=f_{d}−f₂ (7)
Where, \dot{x}₂ is the velocity correction amount of the slave robot, namely the actual velocity of the slave robot; e_{f} is the force error value of the slave robot; ė_{f} is a force change rate error value of the slave robot; kₚ_{_{f}} is a force control proportional coefficient; k_{d}_{_{f}} is a force control derivative coefficient; f_{d} is the desired acting force of the slave robot; and f₂ is the actual applied force of the slave robot.
